(19) United States
(12) Patent Application Publication
(10) Pub. No.: US 2022/0014625 A1
(43) Pub. Date: Jan. 13, 2022

(54) COMMUNICATION TERMINAL DEVICE, CONTROL DEVICE, COMMUNICATION CONTROL METHOD, AND NON-TRANSITORY, COMPUTER-READABLE CONTROL MEDIUM

(71) Applicant: SHARP KABUSHIKI KAISHA, Osaka (JP)

(72) Inventor: MASAKATSU MITANI, Osaka (JP)

(21) Appl. No.: 17/369,888

(22) Filed: Jul. 7, 2021

(30) Foreign Application Priority Data
Jul. 8, 2020 (JP) 2020-117983

(51) Int. Cl. H04M 3/523

(52) U.S. Cl. CPC H04M 3/523

(57) ABSTRACT

A communication terminal device includes: at least one control device; and at least one communication device, the control device performing: an identification process of identifying an attribute of each of other communication terminal devices communicable with the communication terminal device; and a transmission process of transmitting a call request via the communication device to those other communication terminal devices the attribute of each of which is identified as being set to a second attribute that differs from a first attribute to which an attribute of the communication terminal device is set, wherein no call request is transmitted to those other communication terminal devices the attribute of each of which is identified as being set to the first attribute.

### CROSS-REFERENCE TO RELATED APPLICATION

The present application claims priority from Japanese Application JP2020-117983, the content to which is hereby incorporated by reference into this application.

### BACKGROUND OF THE INVENTION

### 1. Field of the Invention

The present invention relates to communication terminal devices, control devices, communication control methods, and non-transitory, computer-readable control media.

### 2. Description of the Related Art

People use communication terminal devices to make telephone calls in a variety of situations. Various call control techniques have been developed that are suitable for usage. For instance, Japanese Unexamined Patent Application Publication, Tokukaihei, No. 11-298608 detailed below discloses a control system for an internal call system using push-button telephones. When a first one of the telephones in the internal call system fails to get a response from a second one of the telephones in an attempt to make an internal call thereto, the control system allows the first telephone to call all the telephones in a group to which the second telephone belongs.

Global virus pandemic and other concerns have created a need for an attendant to attend to a customer without direct person-to-person contact. For instance, at a traditional hotel's check-in counter, a few attendants often attend to many customers. This scheme inevitably involves face-to-face contact, creating opportunities for spreading diseases. We need a new scheme that enables the attendant to attend to customers without making a face-to-face contact.

The control system of Japanese Unexamined Patent Application Publication, Tokukaihei, No. 11-298608, as an example, may be installed, enabling the customer to make an internal call to an attendant on the telephone from the check-in counter. The attendant can hence avoid face-to-face contact in attending to the customer. However, an internal-call telephone allows calls to personnel other than the customer attendants. The customer may make a call to a non-attendant by mistake and cause inconveniences.

The attendant may be able to attend to the customer without making a face-to-face contact by using a communication terminal device such as a common mobile phone instead of the internal call system. The communication terminal device, disposed available to the customer, however can be used for calls to unintended persons.

The present invention, in an aspect thereof, has an object to provide, for example, a communication terminal device that is both capable of making it easier for an attendant to attend to customers without making a face-to-face contact and difficult to be used for unintended purposes.

To address these issues, the present invention, in an aspect thereof, is directed to a communication terminal device including: at least one control device; and at least one communication device, the control device performing: an identification process of identifying an attribute of each of other communication terminal devices communicable with the communication terminal device, the attribute including a first attribute and a second attribute; and a transmission process of transmitting a call request via the communication device to those other communication terminal devices the attribute of each of which is identified as being set to the second attribute that differs from the first attribute to which an attribute of the communication terminal device is set, wherein no call request is transmitted to those other communication terminal devices the attribute of each of which is identified as being set to the first attribute.

To address the issues, the present invention, in another aspect thereof, is directed to a control device that controls an operation of a communication terminal device, the control device including: an identification unit configured to identify an attribute of each of other communication terminal devices communicable with the communication terminal device, the attribute including a first attribute and a second attribute; and a transmission control unit configured to transmit a call request to those other communication terminal devices the attribute of each of which is identified as being set to the second attribute that differs from the first attribute to which an attribute of the communication terminal device is set and to transmit no call request to those other communication terminal devices the attribute of each of which is identified as being set to the first attribute.

To address the issues, the present invention, in a further aspect thereof, is directed to a communication control method of controlling communications between a plurality of communication terminal devices by means of either any of the plurality of communication terminal devices or an information processing device communicable with the plurality of communication terminal devices, each of the plurality of communication terminal devices having an attribute including a first attribute and a second attribute, the method including: the identification step of identifying the attribute of each of the plurality of communication terminal devices; and the transmission step of transmitting a call request to those of the plurality of communication terminal devices the attribute of each of which is identified as being set to the second attribute that differs from the first attribute to which the attribute of one of the plurality of communication terminal devices that is a sender of the call request is set, wherein in the transmission step, no call request is transmitted to those of the plurality of communication terminal devices the attribute of each of which is identified as being set to the first attribute.

The present invention, in an aspect thereof, can make it easier for an attendant to attend to customers without making a face-to-face contact. A communication terminal device in accordance with an aspect of the present invention is difficult to be used for unintended purposes.

### BRIEF DESCRIPTION OF THE DRAWINGS

FIG. 1 is a block diagram of an exemplary configuration of major components of a communication terminal device in accordance with Embodiment 1 of the present invention.

FIG. 2 is an overview of a communication system in accordance with an aspect of the present invention.

FIG. 3 is a diagram of examples of device management information.

FIG. 4 is an illustration of an exemplary transmission operation reception screen displayed by the communication terminal device.

FIG. 5 is a flow chart representing an exemplary process from the setting of the mode of operation to the registration of contacts on the communication terminal device.

FIG. 6 is a flow chart representing an exemplary process performed in transmission by the communication terminal device.

FIG. 7 is a flow chart representing an exemplary process performed in reception of a call request by the communication terminal device.

FIG. 8 is an illustration of an example of a communication terminal device in client mode automatically performing a call request transmission process in response to a detection of a person.

FIG. 9 is an overview of call control implemented by a communication system in accordance with Embodiment 2 of the present invention.

### DETAILED DESCRIPTION OF THE INVENTION

### Embodiment 1

### System Configuration

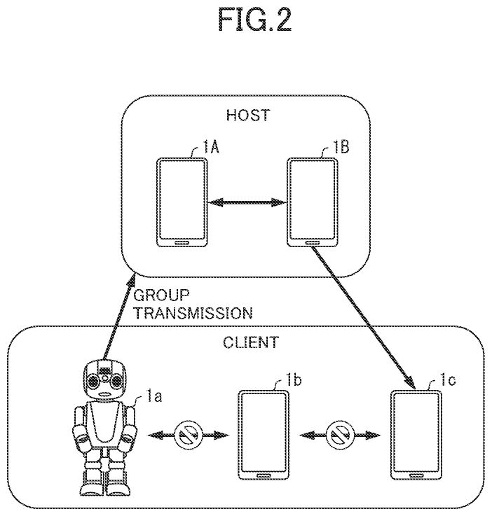

FIG. 2 is an overview of a communication system in accordance with an aspect of the present invention. Referring to FIG. 2, the communication system includes communication terminal devices 1a to 1c operating in client mode (first attribute) and communication terminal devices 1A and 1B operating in host mode (second attribute). The communication terminal devices 1a to 1c, 1A, and 1B will be simply referred to as the communication terminal devices 1 throughout the following description unless they need to be distinguished from one another. The communication terminal device 1 has an attribute that is set to either client mode or host mode as described here and operates in accordance with the attribute setting.

In the example shown in FIG. 2, the communication terminal device 1a is of a robot type, and all the other communication terminal devices 1b, 1c, 1A, and 1B are smartphones. This is, needless to say, a mere example. The communication terminal devices 1a to 1c, 1A, and 1B may be any communication terminal devices capable of making a telephone call under a scheme. The communication system includes at least two communication terminal devices. FIG. 2, showing five communication terminal devices, is a mere example.

The communication terminal device 1 operating in client mode make a group transmission to the communication terminal devices 1 operating in host mode. A group transmission is a simultaneous transmission of call requests to two or more of the communication terminal devices 1. Upon receiving a group transmission, the communication terminal device 1 notifies the user of an incoming call by sound, light, vibration, or a combination thereof. The first communication terminal device 1 answering to the call request is made available for a call with the originating communication terminal device 1. As an example, a call request made by the communication terminal device 1a is a group transmission with both the communication terminal devices 1A and 1B operating in host mode being designated as destinations.

The communication terminal device 1 operating in client mode does not transmit a communication request to the other communication terminal devices 1 operating in client mode. For instance, the communication terminal device 1a, since operating in client mode, does not transmit a communication request to the communication terminal devices 1b and 1c which are operating likewise in client mode. The communication terminal device 1a is therefore not available for a call with the communication terminal device 1b or the communication terminal device 1c.

On the other hand, the communication terminal device 1 operating in host mode can transmit a communication request to the communication terminal device 1 operating in client mode. The user can talk on the communication terminal device 1 if he/she responds to this communication request by performing a call reception operation on the communication terminal device 1. For instance, the communication terminal device 1B, operating in host mode, can make a call to the communication terminal device 1c as shown in FIG. 2. Similarly, the communication terminal device 1B can make a call to the communication terminal devices 1a and 1b. The communication terminal device 1B can also make a call to the communication terminal device 1A operating likewise in host mode.

This communication system readily enables an attendant to attend to customers without making a face-to-face contact in, for example, the hospitality industry and medical facilities. In a hotel, as an example, the customer may use one of the communication terminal devices 1a to 1c whilst the attendants may use the communication terminal devices 1A and 1B.

In these situations, if the customer needs to get in contact with an attendant, he/she can use one of the communication terminal devices 1a to 1c to make a group transmission to the communication terminal devices 1A and 1B so that he/she can talk to one of the attendants through either the communication terminal device 1A or 1B. Since no call request is transmitted between the communication terminal devices 1a to 1c, no unintended calls are allowed between customers. Additionally, the attendant can use either the communication terminal device 1A or 1B to talk to a particular customer or another attendant.

### Device Configuration

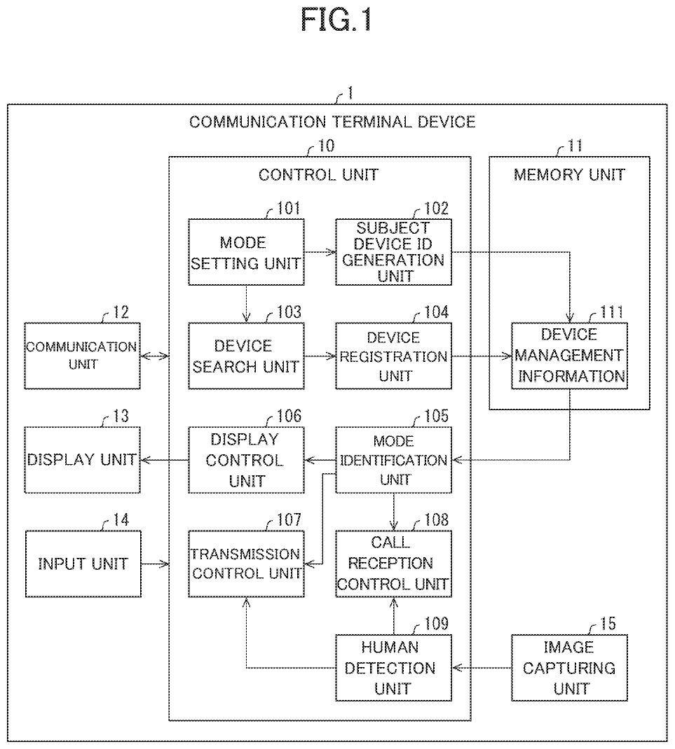

The configuration of the communication terminal device 1 is now described in more detail with reference to FIG. 1. FIG. 1 is a block diagram of an exemplary configuration of major components of the communication terminal device 1. Referring to FIG. 1, the communication terminal device 1 includes a control unit 10, a memory unit 11, a communication unit 12, a display unit 13, an input unit 14, and an image capturing unit 15. The memory unit 11, the communication unit 12, the display unit 13, the input unit 14, and the image capturing unit 15 may be provided external to the communication terminal device 1. In addition to the blocks shown in FIG. 1, the communication terminal device 1 further includes, for example, an audio input unit for receiving an audio input from the user of the communication terminal device 1 and an audio output unit for audio output.

The control unit 10 collectively controls these and other units of the communication terminal device 1. The control unit 10 includes a mode setting unit 101, a subject device ID generation unit 102, a device search unit 103, a device registration unit 104, a mode identification unit 105, a display control unit 106, a transmission control unit 107, a call reception control unit 108, and a human detection unit 109. Any at least one control device such as a CPU (central processing unit) may be used to provide the functions of these units.

The memory unit 11 stores various data for use by the communication terminal device 1. In example of FIG. 1, the memory unit 11 contains device management information 111. The functions of the memory unit 11 may be provided by any one or more storage devices. The communication unit 12 enables communications between the communication terminal device 1 and other devices (specifically, other communication terminal devices 1). The functions of the communication unit 12 may be provided by any one or more communication devices.

The display unit 13 displays an image thereon. The functions of the display unit 13 may be provided by any display device. The communication terminal device 1 receives inputs from the user through the input unit 14. For instance, if the communication terminal device 1 includes a touch panel, the touch panel provides the functions of the display unit 13 and the input unit 14. The image capturing unit 15 captures moving images, still images, and/or other images. The functions of the image capturing unit 15 may be provided by any image capturing device such as a camera.

The mode setting unit 101 sets the mode of operation of the communication terminal device 1 to, as described earlier, either client mode or host mode. The mode setting unit 101 may set the mode of operation in any manner. For instance, the mode setting unit 101 may set the mode of operation in accordance with a choice made by the user of the communication terminal device 1.

If, as an example, application software (hereinafter, “applications”) is installed in the communication terminal device 1 to provide the functions of the control unit 10, separate applications may be prepared for client mode and for host mode. When this is the case, the mode setting unit 101 in the client-mode application sets the mode of operation of the communication terminal device 1 to client mode, and the mode setting unit 101 in the host-mode application sets the mode of operation of the communication terminal device 1 to host mode.

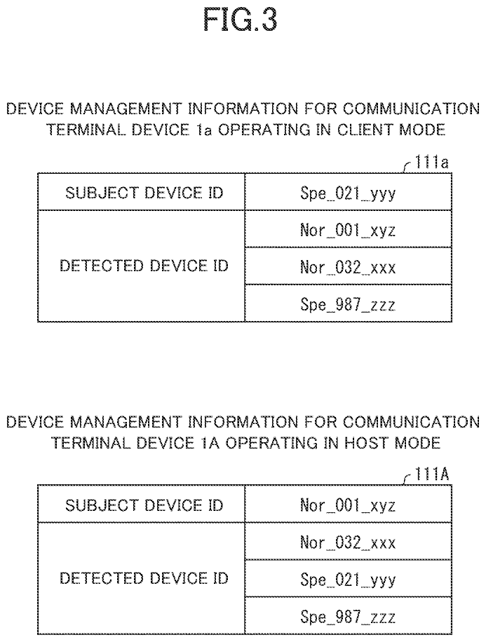

The subject device ID generation unit 102 generates a device ID for the communication terminal device 1 in which the subject device ID generation unit 102 resides. An ID (identification) is identification information that enables identifying the communication terminal device 1 in which the subject device ID generation unit 102 resides among communication terminal devices. The subject device ID generation unit 102 may generate a device ID that contains information representing the mode of operation of the communication terminal device 1 in which the subject device ID generation unit 102 resides, the mode of operation being set by the mode setting unit 101. In such a case, the device ID serves to identify both the communication terminal device 1 in which the subject device ID generation unit 102 resides and the mode of operation of the communication terminal device 1. Examples of the device ID will be described later with reference to FIG. 3.

The device search unit 103 searches for a communication terminal device 1 that can communicate with the communication terminal device 1. Assume, as an example, that the communication terminal devices 1 communicate over a common network (e.g., a local area network), in which case the device search unit 103 may detect a communication terminal device having a prescribed device ID setting among the communication terminal devices connected to the network to which the communication terminal device 1 is connected.

The device registration unit 104 registers the communication terminal devices 1 that can communicate with the communication terminal device 1 in which the device registration unit 104 resides in the device management information 111. Since the device search unit 103 detects those communication terminal devices 1 that can communicate with the communication terminal device 1 in which the device registration unit 104 resides as described above, the device registration unit 104 registers the communication terminal devices 1 detected by the device search unit 103.

The mode identification unit 105 identifies the attributes of the communication terminal device 1 in which the mode identification unit 105 resides and the other communication terminal devices 1. More particularly, the mode identification unit 105 identifies whether the mode of operation of each of the communication terminal device 1 in which the mode identification unit 105 resides and the other communication terminal devices 1 is set to client mode or host mode. For example, the mode identification unit 105 may identify the mode of operation of each communication terminal device 1 by referring to the device management information 111. Details will be given later.

The display control unit 106 causes the display unit 13 to display images. For instance, the display control unit 106 causes the display unit 13 to display a UI (user interface) screen enabling the user of the communication terminal device 1 to perform a call request transmission operation.

The transmission control unit 107 performs a transmission process to transmit a call request via the communication unit 12. The transmission control unit 107 has different sets of functions depending on the mode of operation of the communication terminal device 1 in which the transmission control unit 107 resides. Specifically, when the communication terminal device 1 in which the transmission control unit 107 resides is operating in client mode, the transmission control unit 107 transmits a call request to those other communication terminal devices 1 identified by the mode identification unit 105 as operating in host mode. In other words, the transmission control unit 107 performs a group transmission to the communication terminal devices 1 operating in host mode. Meanwhile, when the communication terminal device 1 in which the transmission control unit 107 resides is operating in client mode, the transmission control unit 107 does not transmit a call request to those other communication terminal devices 1 identified by the mode identification unit 105 as operating in client mode.

On the other hand, when the communication terminal device 1 in which the transmission control unit 107 resides is operating in host mode, the transmission control unit 107 transmits a call request to one of the communication terminal devices 1 specified by the user of the communication terminal device 1. In other words, when the communication terminal device 1 in which the transmission control unit 107 resides is operating in host mode, the transmission control unit 107 transmits a call request to a specified one of the communication terminal devices 1 regardless of the mode of operation of the destination device.

The call reception control unit 108 performs a call reception process of starting a call with a communication terminal device in response to a call request coming from the communication terminal device. The call reception control unit 108 has different sets of functions depending on the mode of operation of the communication terminal device 1 in which the call reception control unit 108 resides. Specifically, when the communication terminal device 1 in which the call reception control unit 108 resides is operating in client mode, the call reception control unit 108 starts a call in response to an incoming call request, irrespective of the operation by the user of the communication terminal device 1 if the human detection unit 109 has detected a person in the vicinity of the communication terminal device 1. On the other hand, when the communication terminal device 1 in which the call reception control unit 108 resides is operating in host mode, the call reception control unit 108 starts a call in response to a call reception operation by the user of the communication terminal device 1. The function of starting a call irrespective of the user's call reception operation or the lack of it is not essential. A call may be started in response to a call reception operation by the user in either mode of operation.

The human detection unit 109 detects a person in the vicinity of the communication terminal device 1 in which the human detection unit 109 resides. The “vicinity” in this context refers to a spatial range in which the user can make a call through the communication terminal device 1 and may be, for example, within a radius of a few meters from the communication terminal device 1. Specifically, the human detection unit 109 detects a person by analyzing an image of the vicinity of the communication terminal device 1 captured by the image capturing unit 15. A person may be detected by any other method. For instance, a person may be detected using an infrared light sensor. The human detection unit 109 may be omitted if there is no need to implement control based on the detection of a person.

The device management information 111 is information for managing with which communication terminal devices 1 the communication terminal device 1 is allowed to communicate. The device registration unit 104 registers, in the device management information 111, those communication terminal devices 1 with which the communication terminal device 1 in which the device registration unit 104 resides is allowed to communicate, as described above. The device management information 111 further contains information representing the mode of operation of each communication terminal device 1. The device management information 111 will be described below in detail with reference to FIG. 3.

### Examples of Device Management Information

FIG. 3 is a diagram of examples the device management information 111. More particularly, FIG. 3 shows device management information 111a stored in the communication terminal device 1a operating in client mode and device management information 111A stored in the communication terminal device 1A operating in host mode.

The device management information 111a contains an ID (identification information), “Spe_021_yyy,” as the device ID of the communication terminal device 1a (“subject device ID”). The device management information 111a further contains device IDs, “Nor_001_xyz,” “Nor_032_xxx,” and “Spe_987_zzz,” as the device IDs of the communication terminal devices 1 detected by the communication terminal device 1a (more particularly, by the device search unit 103) (“detected device IDs”).

The character string, “Spe,” in these device IDs indicate that the devices are operating in client mode. Meanwhile, the character string, “Nor,” in these device IDs indicate that the devices are operating in host mode. Accordingly, the device ID, “Spe_021_yyy,” of the communication terminal device 1a indicates that the communication terminal device 1a is operating in client mode. This inclusion of prescribed information in the device ID enables the device search unit 103 to use this information in detecting those communication terminal devices 1 which can be candidate call destinations.

The mode identification unit 105 in the communication terminal device 1a can identify the modes of operation of the communication terminal device 1 in which the mode identification unit 105 resides and the other communication terminal devices 1 by referring to the device management information 111a. Then, the transmission control unit 107 in the communication terminal device 1a can control transmission on the basis of the modes of operation identified by the mode identification unit 105.

For instance, by referring to the device management information 111a shown in FIG. 3, the mode identification unit 105 identifies the communication terminal device 1 in which the mode identification unit 105 resides as operating in client mode as described above. The mode identification unit 105 identifies, of the three detected communication terminal devices 1, “Nor_001_xyz” and “Nor_032_xxx” as operating in host mode and “Spe_987_zzz” as operating in client mode.

In response to a transmission operation on the communication terminal device 1a in this situation, the transmission control unit 107 performs a group transmission to both “Nor_001_xyz” and “Nor_032_xxx,” but does not transmit a call request to “Spe_987_zzz.” The device management information 111a may not contain the device ID of the communication terminal device 1 operating in client mode because the communication terminal device operating in client mode does not transmit a call request to the other communication terminal devices 1 operating in client mode as described here.

The device management information 111A contains “Nor_001 xyz” registered as the subject device ID and “Nor 032_xxx,” “Spe_21yyy,” and “Spe_987_zzz” registered as detected device IDs. The mode identification unit 105 in the communication terminal device 1A therefore identifies the communication terminal device 1A as operating in host mode and also identifies, of the three detected communication terminal devices 1, “Nor_032_xxx” as operating in host mode and “Spe_021yyy” and “Spe_987_zzz” as operating in client mode.

In this situation, the transmission control unit 107 in the communication terminal device 1A is allowed to transmit a call request to any of “Nor_032_xxx,” “Spe_21_yyy,” and “Spe_987_zzz.” By using the device management information 111a and 111A shown in FIG. 3 in this manner, the transmission control shown in FIG. 2 can be performed.

The device management information 111 needs only to have such a data structure as to identify the mode of operation of each communication terminal device 1 and is not necessarily limited to the example shown in FIG. 3. For instance, the device management information 111 may have a data structure in which the device ID of each communication terminal device 1 is associated with information representing the mode of operation of the communication terminal device 1, in which case the device ID does not need to contain information representing the mode of operation.

### Example of Transmission Operation Reception Screen

As described earlier, the communication terminal device 1 transmits a call request to different destinations depending on whether the communication terminal device 1 is operating in client mode or host mode. The communication terminal device 1 therefore can preferably display different transmission operation reception screens depending on whether the communication terminal device 1 is operating in client mode or host mode.

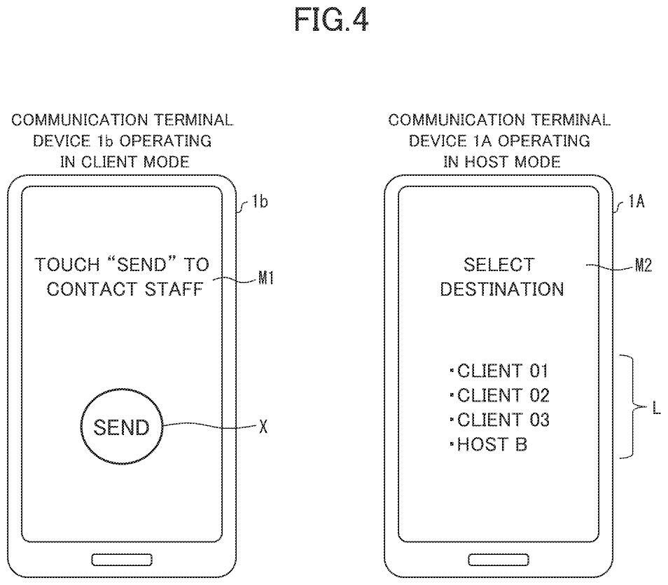

FIG. 4 is an illustration of an exemplary transmission operation reception screen displayed by the communication terminal device L. More particularly, FIG. 4 shows an exemplary transmission operation reception screen displayed by the communication terminal device 1b operating in client mode and an exemplary destination selection screen displayed by the communication terminal device 1A operating in host mode.

The reception screen on the communication terminal device 1b shown in FIG. 4 displays an object X including text “SEND.” The reception screen also displays a message M1 prompting an input operation on the object X. The display of this reception screen helps the user of the communication terminal device 1b readily understand what operation needs to be done to make a call through the communication terminal device 1b.

The user can perform a group transmission by a single touch if the transmission control unit 107 is configured to perform a group transmission to the communication terminal devices 1 operating in host mode in response to an input operation on the object X. As an example, if the communication terminal device 1b configured to display such a reception screen is disposed at a reception of, for example, a company, and each staff member who can attend to a visitor is given the communication terminal device 1 operating in host mode, a visitor can be smoothly attended to without making a face-to-face contact.

Meanwhile, the reception screen on the communication terminal device 1A shown in FIG. 4 displays a list L of those communication terminal devices 1 which are candidate destinations. The communication terminal devices 1 in the list L are detected by the device search unit 103 as being communicable with the communication terminal device 1A. The reception screen also displays a message M2 prompting a destination selection operation. The display of this selection screen helps the user of the communication terminal device 1A select a desired one of the communication terminal devices 1 to smoothly perform an operation of transmitting a call request to that communication terminal device 1.

The selection screen on the communication terminal device 1A shown in FIG. 4 displays a name for the communication terminal device 1 instead of the device ID found in the device management information 111A shown in FIG. 3. To display a desired name, the name may be registered beforehand in association with the device ID.

Process Flow from Mode Setting to Registration

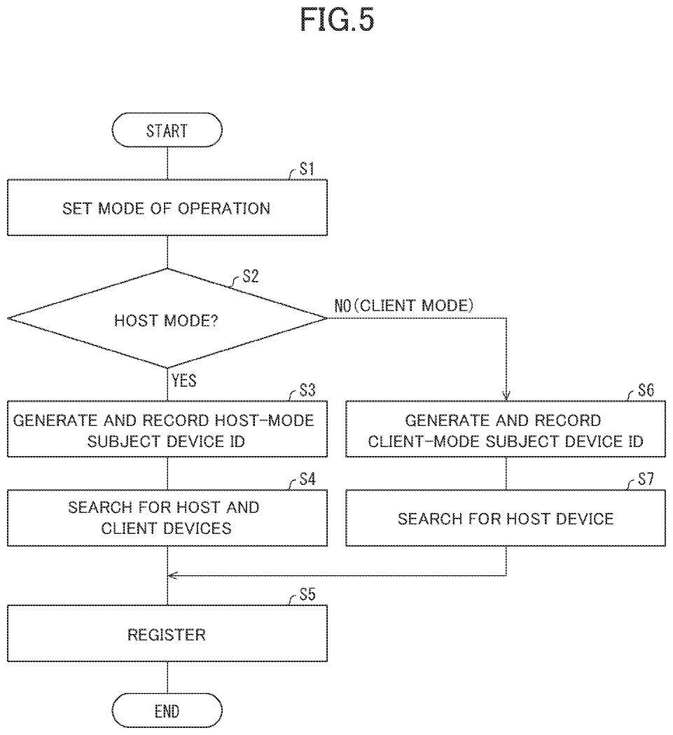

Referring to FIG. 5, a process flow is now described from the setting of the mode of operation of the communication terminal device 1 by the communication terminal device 1 to the registration of another, destination communication terminal devices 1. FIG. 5 is a flow chart representing an exemplary process from the setting of the mode of operation to the registration of contacts on the communication terminal device 1. The process shown in FIG. 5 may be carried out any time before a call is made on the communication terminal device 1, for example, when an application that provides the functions of the control unit 10 is started for the first time on the communication terminal device 1.

The mode setting unit 101 sets the mode of operation of the communication terminal device 1 in step S1. The mode of operation may be set in any manner. As an example, the mode setting unit 101 may cause the display unit 13 to display a screen that prompts a selection of either host mode or client mode, so that the user can select either mode of operation.

In step S2, the subject device ID generation unit 102 determines whether the communication terminal device 1 in which the subject device ID generation unit 102 resides has been set to host mode or client mode in step S1. If the subject device ID generation unit 102 determines that the communication terminal device 1 has been set to host mode (YES in step S2), the process proceeds to step S3; if the subject device ID generation unit 102 determines that the communication terminal device 1 has been set to client mode (NO in step S2), the process proceeds to step S6.

In step S3, the subject device ID generation unit 102 generates and records a host-mode subject device ID in the device management information 111. The host-mode subject device ID contains information representing that the communication terminal device 1 is operating in host mode as described above with reference to FIG. 3. Alternatively, instead of generating a subject device ID containing information representing that the communication terminal device 1 is operating in host mode, the subject device ID generation unit 102 may record, in association with the generated subject device ID, information representing that the communication terminal device 1 is operating in host mode.

In step S4, the device search unit 103 searches for the other communication terminal devices 1 that can communicate with the communication terminal device 1 in which the device search unit 103 resides. The device search unit 103 searches for both the communication terminal devices 1 operating in host mode and the communication terminal devices 1 operating in client mode. As an example, the device search unit 103 may detect communication terminal devices having a host-mode or client-mode device ID as the communication terminal devices 1, out of the communication terminal devices connected to the local area network to which the communication terminal device 1 in which the device search unit 103 resides is connected.

In step S5, the device registration unit 104 registers every communication terminal device 1 detected in step S4 in the device management information 111, which concludes the process shown in FIG. 5. Specifically, in step S5, the device registration unit 104 records the device IDs of the communication terminal devices 1 detected in step S4 as detected device IDs in the device management information 111 (see FIG. 3). The device registration unit 104 may notify the communication terminal device 1 where the device IDs are recorded of a subject device ID, so that the communication terminal device 1 can record the subject device ID.

Not all the communication terminal devices 1 detected in step S4 need to be registered in step S5. For instance, the display unit 13 may display a list of the detected communication terminal devices 1, so that the device registration unit 104 can register only those communication terminal devices 1 which are selected by the user of the communication terminal device 1 in which the device registration unit 104 resides.

In step S6, the subject device ID generation unit 102 generates and records a client-mode subject device ID in the device management information 111. The client-mode subject device ID contains information representing that the communication terminal device 1 is operating in client mode as described above with reference to FIG. 3. Alternatively, instead of generating a subject device ID containing information representing that the communication terminal device 1 is operating in client mode, the subject device ID generation unit 102 may record, in association with the generated subject device ID, information representing that the communication terminal device 1 is operating in client mode.

In step S7, the device search unit 103 searches for the other communication terminal devices 1 that can communicate with the communication terminal device 1 in which the device search unit 103 resides. The device search unit 103 searches for the communication terminal devices 1 operating in host mode. The process then proceeds to step S5 where the device registration unit 104 registers every communication terminal device 1 detected in step S7 in the device management information 111. Not all the communication terminal devices 1 detected in step S7 need to be registered similarly to step S5 which follows step S4.

As demonstrated in the description above, the communication system using the communication terminal devices 1 enables an attendant to attend to customers without making a face-to-face contact, through a simple job of registering a device ID on each communication terminal device 1 without having to introduce the conventional internal call system described earlier.

### Addition of Communication Terminal Device

An additional communication terminal device 1 may be incorporated after the communication terminal devices 1 are registered in the device management information 111 as described in the foregoing. If there is registered a plurality of communication terminal devices 1 operating in host mode, it is also possible to designate one of the communication terminal devices 1 (e.g., the one that is registered first or specified by the user) as a base device and the other communication terminal devices 1 as extension devices, so that the base device can manage the extension devices.

In such a case, the base device, which is one of the communication terminal devices 1 operating in host mode, may detect the other communication terminal devices 1 operating in host mode through the device search unit 103, so that the device registration unit 104 can register the detected communication terminal devices 1 in the device management information 111. The base device, in this case, transmits a subject device ID to the registered communication terminal device 1 to have the subject device ID registered.

In incorporating a new communication terminal device 1 as an extension device operating in host mode, the user of the new communication terminal device 1 may detect the communication terminal device 1 that is a base device operating in host mode through the device search unit 103 and register the detected communication terminal device 1 in the device management information 111 through the device registration unit 104, in which case the extension device transmits a subject device ID to the base device to have the subject device ID registered.

### Process Flow in Transmission

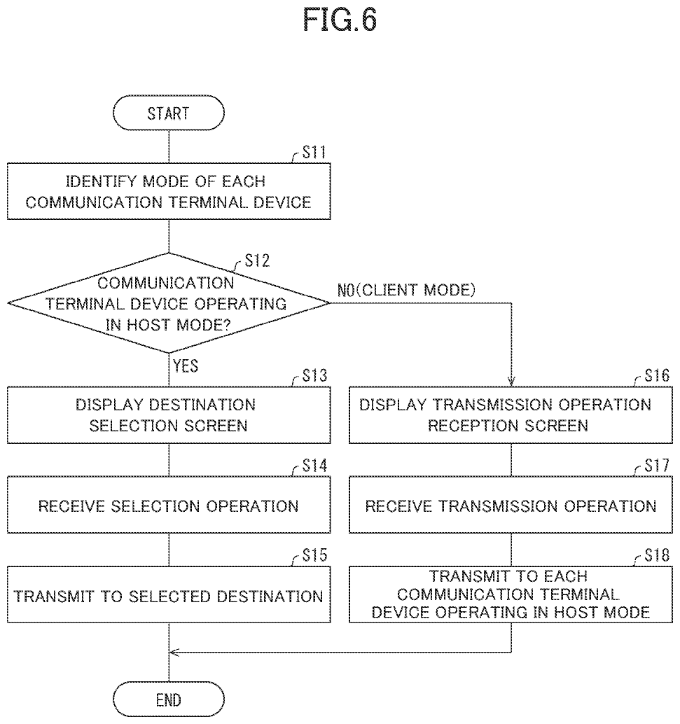

Referring to FIG. 6, a process flow is now described that is performed by the communication terminal device 1 in transmitting a call request (communication control method). FIG. 6 is a flow chart representing an exemplary process performed in the transmission by the communication terminal device 1. FIG. 6 does not show a post-transmission process because the post-transmission process is similar to a common call control process.

In step S11 (identification step), the mode identification unit 105 identifies the mode of operation of each communication terminal device 1 that is communicable with the communication terminal device 1 in which the mode identification unit 105 resides, by referring to the device management information 111. Prior to step S11, the device search unit 103 may search for communication terminal devices so that the device registration unit 104 can register the detected communication terminal devices 1 in the device management information 111. This optional configuration updates the device management information 111 before a call request is transmitted.

The mode identification unit 105, in step S12, determines whether or not the communication terminal device 1 in which the mode identification unit 105 resides is operating in host mode. If the mode identification unit 105 determines that the communication terminal device 1 is operating in host mode (YES in step S12), the process proceeds to step S13. On the other hand, if the mode identification unit 105 determines that the communication terminal device 1 is operating in client mode (NO in step S12), the process proceeds to step S16.

In step S13, the display control unit 106 causes the display unit 13 to display a destination selection screen, which may be similar to the screen on the communication terminal device 1A shown in FIG. 4. In such a case, the display control unit 106 may cause the display unit 13 to display, for example, the name and ID of each communication terminal device 1 registered in the device management information 111 as candidate destinations.

In step S14, the transmission control unit 107 receives a destination selection operation through the input unit 14. Then, in step S15, the transmission control unit 107 transmits a call request to the selected destination. A subsequent call reception operation at the destination enables a call.

In step S16, the display control unit 106 causes the display unit 13 to display a transmission operation reception screen, which may be similar to the screen on the communication terminal device 1b shown in FIG. 4. Subsequently, in step S17, the transmission control unit 107 receives a transmission operation through the input unit 14. When the display unit 13 displays the reception screen shown on the communication terminal device 1b in FIG. 4, an input operation on the object X serves as a transmission operation.

In step S18 (transmission step), the transmission control unit 107 transmits a call request to the communication terminal devices 1 operating in host mode. Specifically, the transmission control unit 107 transmits a call request to each communication terminal device 1 having a device ID indicating that the communication terminal device 1 is operating in host mode, out of the communication terminal devices 1 registered in the device management information 111. In step S18, the transmission control unit 107 does not transmit a call request to the communication terminal devices 1 operating in client mode. A subsequent call reception operation on any of the communication terminal devices 1 operating in host mode enables a call with that communication terminal device 1.

### Process Flow in Reception

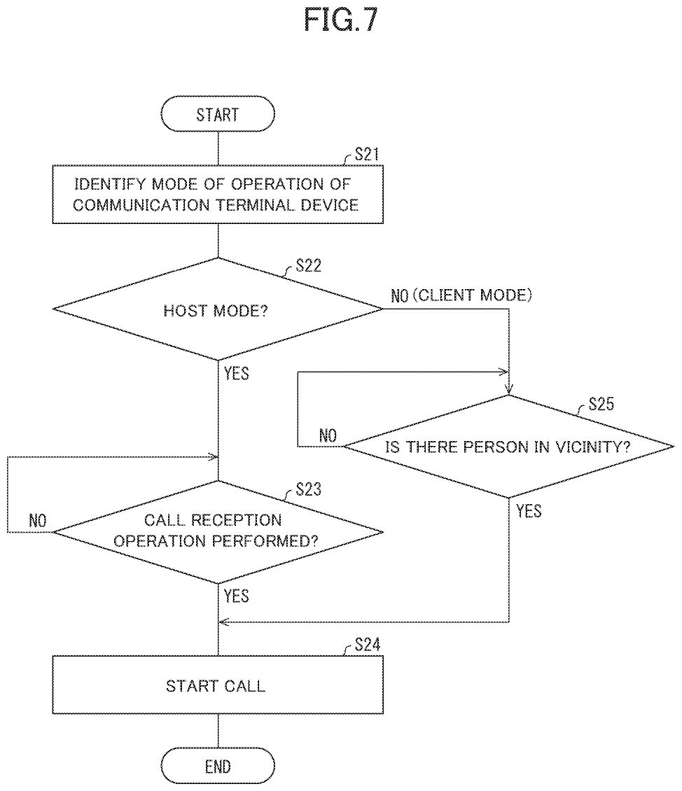

Referring to FIG. 7, a process flow is now described that is performed by the communication terminal device 1 in receiving a call request. FIG. 7 is a flow chart representing an exemplary process performed by the communication terminal device 1 in receiving of a call request. FIG. 7 does not show a process that follows a start of a call because the process that follows a start of a call is similar to a common call control process.

In step S21, the mode identification unit 105 identifies the mode of operation of the communication terminal device 1 in which the mode identification unit 105 resides, by referring to the device management information 111. Then, in step S22, the mode identification unit 105 determines whether or not the communication terminal device 1 in which the mode identification unit 105 resides is operating in host mode. If the mode identification unit 105 determines that the communication terminal device 1 is operating in host mode (YES in step S22), the process proceeds to S23. On the other hand, if the mode identification unit 105 determines that the communication terminal device 1 is operating in client mode (NO in step S22), the process proceeds to S25.

In step S23, the call reception control unit 108 determines whether or not a call reception operation has been received. If the call reception control unit 108 determined that a call reception operation has been received (YES in step S23), the call reception control unit 108 proceeds to S24 where a call is started with the communication terminal device 1 that is the sender of the call request. On the other hand, if the call reception control unit 108 fails to determine that a call reception operation has been received (NO in step S23), the call reception control unit 108 continues to stand by for a call reception operation. When the call request ends before it is determined “YES” in step S23, the process is ended without starting a call.

In step S25, the human detection unit 109 determines, on the basis of an image captured by the image capturing unit 15 of the surroundings of the communication terminal device 1 in which the human detection unit 109 resides, whether or not there is a person in the vicinity of the communication terminal device 1. If the human detection unit 109 determines that there is a person in the vicinity (YES in step S25), the process proceeds to S24 where the call reception control unit 108 starts a call.

On the other hand, if the human detection unit 109 determines that there is not a person in the vicinity (NO in step S25). S25 is repeated after a prescribed length of time to determine whether or not there is a person in the vicinity. When the call request ends before it is determined “YES” in step S25, the process is ended without starting a call.

As described above, upon receiving a call request from the communication terminal device 1 operating in host mode, the communication terminal device 1 operating in client mode may perform a call reception process of starting a call with the communication terminal device 1 operating in host mode, irrespective of the operation by the user of the communication terminal device 1 operating in client mode. This configuration enables the user of the communication terminal device 1 operating in client mode to start a call with the user of the communication terminal device 1 operating in host mode without having to perform any operations at all.

In the example shown in FIG. 7, a call request is automatically received under the condition that there is a person in the vicinity of the communication terminal device 1 operating in client mode. Alternatively, a call request may be automatically received without checking whether or not there is a person in the vicinity. Assume, as an example, that the user of the communication terminal device 1 operating in client mode is a hospital inpatient who cannot move from the bed by himself/herself and that the communication terminal device 1 is placed on the side of the bed. Because the user is always in the vicinity of the communication terminal device 1, there is no need to check whether or not there is a person in the vicinity. This configuration enables, for example, a medical worker such as a physician or a nurse to easily talk or give instructions to the patient through the communication terminal device 1 operating in host mode.

If the communication terminal device 1 operating in host mode may perform a call reception process if the human detection unit 109 has already detected a person upon receiving a call request. This configuration is applicable when, for example, there is not always a staff member in a place where the communication terminal device 1 operating in host mode is located. As an example, if there is provided a communication terminal device 1 operating in host mode available in a plurality of places that the attendant may work from, the attendant can readily start a call with the customer through the communication terminal device 1 that is in the attendant's actual location upon receiving a call request from the customer.

Automatic Transmission of Call Request from Communication Terminal Device Operating in Client Mode

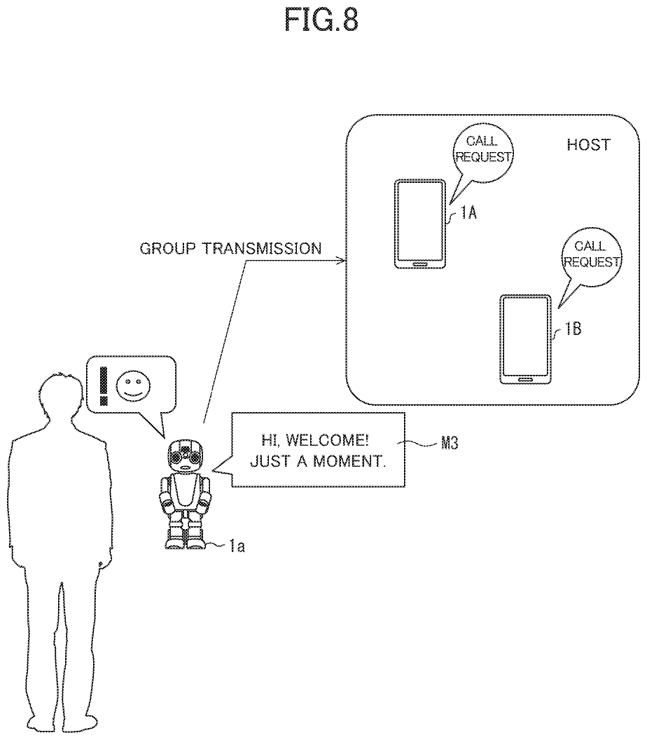

The communication terminal device 1 operating in client mode may automatically perform a call request transmission process irrespective of the operation by the user, which is now described with reference to FIG. 8. FIG. 8 is an illustration of an example of the communication terminal device 1 operating in client mode automatically performing a call request transmission process in response to a detection of a person.

In the example shown in FIG. 8, the communication terminal device 1a, which is of a robot type, detects a visitor. In response to the detection of the visitor, this communication terminal device 1a both outputs a prescribed audio response message M3 and performs a group transmission to the communication terminal devices 1A and 1B operating in host mode. In this situation, the communication terminal device 1a detects a person in the same manner as in step S25 in FIG. 7 before implementing steps S11, S12, and S18 in FIG. 6.

The communication terminal devices 1A and 1B hence receive a call request. Either communication terminal device 1A or 1B, in response to a call reception operation by the user thereof, becomes ready for a talk with the communication terminal device 1a. The visitor therefore only needs to approach the communication terminal device 1a, to start a talk with the user of one of the communication terminal devices 1A and 1B through the communication terminal device 1a.

In the example shown in FIG. 8, the users of the communication terminal devices 1A and 1B talk to the visitor through the same communication terminal device 1a. Accordingly, the communication terminal device 1a may output the voice of the users of the communication terminal devices 1A and 1B after converting the voice. For instance, the communication terminal device 1a may output the voice of the users of the communication terminal devices 1A and 1B after converting the sound quality of the voice to sound quality that is close to the sound quality of the voice outputted by the communication terminal device 1a. This configuration can give the visitor an impression that he/she is talking with a robot when actually the visitor is talking with the users of the communication terminal devices 1A and 1B.

The communication terminal device 1 operating in client mode may automatically transmit a call request in response to the user thereof approaching the communication terminal device 1, in other words, in response to a temporarily decreasing distance between the communication terminal device 1 and the user thereof. In such a case, the communication terminal device 1 may detect the approaching user by, for example, analyzing the images captured by the image capturing unit 15. This configuration is suitable to customer services at, for example, a reception because even when there are already people in the vicinity of the communication terminal device 1 operating in client mode, a group transmission is automatically performed upon another person approaching the communication terminal device 1 operating in client mode.

The communication terminal device 1 operating in client mode may automatically transmit a call request in response to the distance between the communication terminal device 1 and the user thereof having decreased to less than or equal to a threshold value. This configuration is useful in, for example, a hospital inpatient contacting a medical worker carrying the communication terminal device 1 operating in host mode through the communication terminal device 1 operating in client mode, because when, for example, the patient experiences a rapid change in his/her physical condition and wants to contact a medical worker, the patient only needs to approach the communication terminal device 1 operating in client mode to transmit a call request without having to perform any operations at all.

The communication terminal device 1 operating in client mode may automatically transmit a call request when the communication terminal device 1 has failed to detect a person in the vicinity thereof for a prescribed length of time. In this situation, when the communication terminal device 1 operating in host mode responds to this call request by performing a call reception operation, the communication terminal device 1 operating in client mode outputs a prescribed message informing that, for example, there is no person in the vicinity thereof.

Specifically, the communication terminal device 1 operating in client mode needs only to be configured in such a manner that the human detection unit 109 can check at prescribed intervals whether or not there is a person and that if the checking by the human detection unit 109 indicates for a prescribed length of time that there is not a person in the vicinity of the communication terminal device 1, the transmission control unit 107 can perform a group transmission to the communication terminal devices 1 operating in host mode. This configuration can be used in, for example, watching over a person.

Apart from these examples, the communication terminal device 1 operating in client mode may automatically transmit a call request in response to a detection of a prescribed event by, for example, analyzing images captured by the image capturing unit 15. For instance, if disposed in, for example, a hospital room, the communication terminal device 1 operating in client mode may automatically transmit a call request in response to a detection of a rapid change in the physical condition of the patient in image analysis. This detection may be done by, for example, applying a machine-learning-based model trained on images of patients in various physical conditions as training data.

### Switching Modes of Operation

The mode setting unit 101 may set the mode of operation to either client mode or host mode and subsequently switches the mode of operation to another mode of operation in response to an operation by the user on the communication terminal device 1 in which mode setting unit 101 resides. When, for example, the communication terminal device 1 operating in client mode breaks down and there is an insufficient number of malfunctioning communication terminal devices 1 operating in client mode in the network, this configuration enables the communication terminal device 1 operating in host mode to be switched to client mode to replace the broken communication terminal device 1.

However, if the communication terminal device 1 operating in client mode is configured to be freely switchable to host mode, the user of that communication terminal device 1 can freely make a call to the other communication terminal devices 1 operating in client mode. Accordingly, if the communication terminal device 1 is configured to be switchable from client mode to host mode, it is preferable to limit users who are allowed to do the switching, for example, through password authentication.

### Embodiment 2

A description is now given of another embodiment of the present invention. For convenience of description, members of the present embodiment that have the same function as members of the preceding embodiment are indicated by the same reference numerals, and description thereof is not repeated.

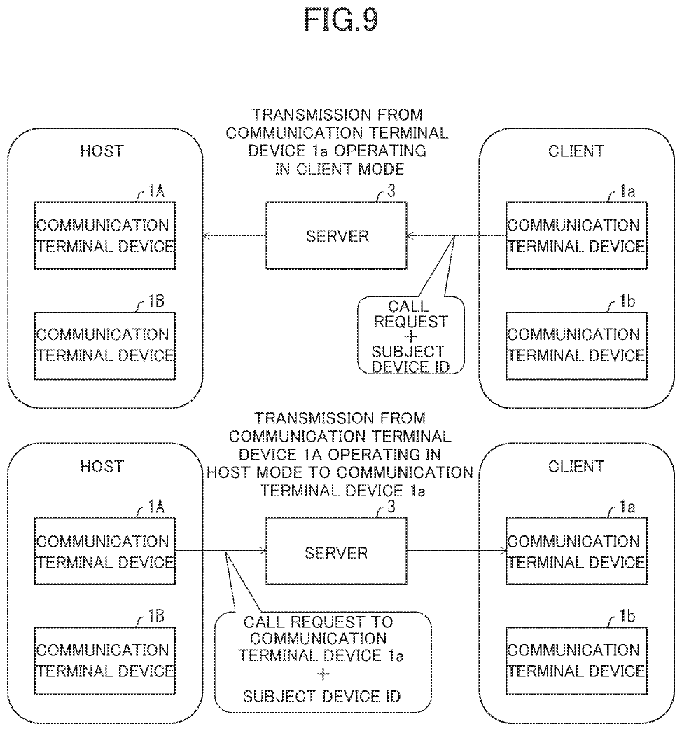

The present embodiment focuses on examples where there is provided a server 3 controlling calls between communication terminal devices 1. FIG. 9 is an overview of call control in a communication system in accordance with the present embodiment. The server 3 is an information processing device that performs, for example, grouping of the communication terminal devices 1 and inter-communication control of the communication terminal devices 1. The information processing device may be referred to as a computer.

The server 3 includes, among others, a control unit, a memory unit, and a communication unit, similarly to the communication terminal device 1. Each of these functions can be achieved by, for example, at least one control device, at least one storage device, and at least one communication device. Call control, similar to the control described in Embodiment 1, is accomplished by the server 3 implementing a communication control method described below.

In the communication system in accordance with the present embodiment, all the communication terminal devices 1 operating in either host mode or client mode are registered with the server 3. Specifically, the server 3 records groups of communication terminal devices 1 operating in either host mode or client mode in association with the device IDs of the communication terminal devices 1. When the device IDs do not contain information representing the mode of operation, the server 3 additionally records information representing the mode of operation in association with the device IDs of the communication terminal devices 1.

The top of FIG. 9 shows an example where the communication terminal device 1a operating in client mode transmits a call request. The transmission control unit 107 in the communication terminal device 1a transmits a call request when prescribed conditions are satisfied, for example, when s transmission operation performed by the user of the communication terminal device 1a is received or when a person is detected in the vicinity of the communication terminal device 1a. The destination of the call request is the server 3. The transmission control unit 107 transmits the subject device ID identified by the mode identification unit 105 as well as the call request.

Upon receiving the call request and the subject device ID of the communication terminal device 1a, the control device in the server 3 identifies the communication terminal device 1 associated with the subject device ID out of the pre-registered communication terminal devices 1. The control device in the server 3 may alternatively search for a device upon receiving a call request, to identify the thus-detected communication terminal device 1 as a candidate device with which the communication terminal device 1a may communicate.

Subsequently, the control device in the server 3 identifies the mode of operation of each identified communication terminal device 1 (identification step) and identifies, out of these communication terminal devices 1, all the communication terminal device 1 operating in host mode. The example shown in FIG. 9 assumes that the communication terminal devices 1A and 1B have been identified as the communication terminal devices 1 operating in host mode.

Upon identifying the communication terminal devices 1A and 1B operating in host mode and registered in association with the communication terminal device 1a operating in client mode, the control device in the server 3 perform a group transmission to these communication terminal devices 1A and 1B (transmission step).

Then, in response to a call reception operation on either one of the communication terminal devices 1A and 1B, the control device in the server 3 enables a call between the communication terminal device 1a and that one of the communication terminal devices 1A and 1B on which the call reception operation has been performed.

The process described above, similarly to Embodiment 1, enables the communication terminal device 1 operating in client mode to perform a group transmission to all the communication terminal devices 1 operating in host mode.

The bottom of FIG. 9 shows an example where the communication terminal device 1A operating in host mode transmits a call request to the communication terminal device 1a operating in client mode. Prior to the transmission, the communication terminal device 1A operating in host mode, although not shown, notifies the server 3 of the subject device ID and obtains from the server 3 the device IDs of the communication terminal devices 1 that are in the same group as the communication terminal device 1A.

The transmission control unit 107 in the communication terminal device 1A transmits a call request when prescribed conditions are satisfied, for example, when a transmission operation and an operation for designating a destination communication terminal device 1 are received that are both performed by the user of the communication terminal device 1A. The destination of the call request is the server 3. The transmission control unit 107 transmits the subject device ID identified by the mode identification unit 105 and the device ID of the communication terminal device 1a as well as the call request.

The control device in the server 3 sends a communication request to the communication terminal device 1a on the basis of the information received from the communication terminal device 1A. Then, in response to a call reception operation on the communication terminal device 1a, the control device in the server 3 enables a call between the communication terminal device 1A and the communication terminal device 1a.

The process described above, similarly to Embodiment 1, enables the communication terminal device 1 operating in host mode to transmit a call request to a designated one of the communication terminal devices 1 operating in client mode. The process also enables the communication terminal device 1 operating in host mode to similarly transmit a call request to a designated one of the communication terminal devices 1 operating in host mode.

### Variation Examples

The foregoing embodiments described examples where the communication terminal device 1 operating in client mode is inhibited from selecting a destination so that the communication terminal device 1 operating in client mode cannot transmit a call request to the other communication terminal devices 1 operating in client mode (see FIG. 4). This is merely an illustrative example, and the communication terminal device 1 operating in client mode may be inhibited from transmitting a call request to the other communication terminal devices 1 operating in client mode by any technique.

As an example, the communication terminal device 1 operating in client mode may display a list of the other, detected communication terminal devices 1 including those operating in client mode, but display such a list with the communication terminal devices 1 operating in client mode being, for example, grayed out, so that the other communication terminal devices 1 operating in client mode cannot be selected. Alternatively, the communication terminal device 1 operating in client mode may display a list in such a manner that the other communication terminal devices 1 operating in client mode can be selected from the list; if a selection is made from the other communication terminal devices 1 operating in client mode, the user is, for example, visually or aurally notified that a call request cannot be transmitted to that communication terminal device 1.

As another alternative, for example, the communication terminal device 1 operating in client mode may be allowed to transmit a call request to the other communication terminal devices 1 operating in client mode, but the communication terminal device 1 receiving the call request may automatically reject the call request. This configuration, similarly to foregoing examples, can preclude a call between the communication terminal devices 1 operating in client mode.

The communication terminal device 1 may make a voice-only call or a “video call” where the videos of both ends are displayed. The communication terminal device 1 may be a mobile device or a stationary device.

### Software Implementation

The control blocks of the communication terminal device 1 and the server 3 (particularly, the various units in the control unit) may be implemented by logic circuits (hardware) fabricated, for example, in the form of integrated circuits (IC chips) and may be implemented by software.

In the latter form of implementation, the communication terminal device 1 and the server 3 includes a computer that executes instructions from control programs or software by which various functions are provided. This computer includes among others at least one processor (control device) and at least one storage medium containing the control programs in a computer-readable format. The processor in the computer then retrieves and runs the control programs contained in the storage medium, thereby achieving the object of the present invention. The processor may be, for example, a CPU. The storage medium may be a “non-transitory, tangible medium” such as a ROM (read-only memory), a tape, a disc/disk, a card, a semiconductor memory, or programmable logic circuitry. The communication terminal device 1 and the server 3 may further include, for example, a RAM (random access memory) for loading the control programs. The control programs may be supplied to the computer via any transmission medium (e.g., over a communication network or by broadcasting waves) that can transmit the control programs. The present invention, in an aspect thereof, encompasses data signals on a carrier wave that are generated during electronic transmission of the control programs.

### Summation

The present invention, in aspect 1 thereof, is directed to a communication terminal device 1 including: at least one control device; and at least one communication device. The control device performs: an identification process of identifying an attribute of each of other communication terminal devices 1 communicable with the communication terminal device 1; and a transmission process of transmitting a call request via the communication device to those other communication terminal devices 1 the attribute of each of which is identified as being set to a second attribute (host mode) that differs from a first attribute (client mode) to which an attribute of the communication terminal device 1 is set in which the control device resides. On the other hand, the control device transmits no call request to those other communication terminal devices 1 the attribute of each of which is identified as being set to the first attribute.

According to this configuration, a transmission process is performed with respect to each other communication terminal device 1 having an attribute identified as being set to the second attribute. Therefore, if any one of the communication terminal devices 1 having the second attribute responds to the call request, the user of the communication terminal device 1 having the first attribute can make a call to the user of that one of the communication terminal devices 1 having the second attribute. Thus, where a customer uses the communication terminal device 1 having the first attribute, and attendants use the respective communication terminal devices 1 having the second attribute, one of the attendants can readily attend to the customer without making a face-to-face contact.

According to this configuration, no call request is transmitted to the other communication terminal devices 1 having an attribute identified as being set to the first attribute. The user of the communication terminal device 1 having the first attribute cannot make a call to the users of the other communication terminal devices 1 having the first attribute through that communication terminal device 1 having the first attribute. The configuration can hence make it less likely for the communication terminal devices 1 to be used for unintended purposes.

In aspect 2 of the present invention, the communication terminal device 1 of aspect 1 thereof may be configured such that upon receiving the call request from one of the other communication terminal devices 1 the attribute of which is identified as being set to the second attribute, the control device performs a call reception process of starting a call with that one of the other communication terminal devices 1 irrespective of whether a user operates or does not operate the communication terminal device.

This configuration enables the user of the communication terminal device 1 having the first attribute to smoothly start a call to the user of one of the communication terminal devices 1 having the second attribute without having to perform any operations at all when a call request is received from the user of that communication terminal device 1 having the second attribute. As an example, where the communication terminal device 1 having the first attribute is disposed in a hospital room, and the communication terminal devices 1 having the second attribute are carried around by a physician or a nurse, the physician or nurse can smoothly talk to the patient. In the same situation, patients who are not familiar with how to use the communication terminal device 1 can initiate a call. The configuration can hence prevent failure of a call to the patient.

In aspect 3 of the present invention, the communication terminal device 1 of aspect 1 or 2 thereof may be configured such that the control device performs the transmission process in response to a detection of a person in a vicinity of the communication terminal device. This configuration enables a transmission process to be performed with respect to each other communication terminal device 1 having an attribute identified as being set to the second attribute (host mode) when there is a person approaching the communication terminal device 1 having an attribute identified as being set to the first attribute (client mode).

The configuration enables the user of the communication terminal device 1 having the first attribute to initiate a call to the user of one of the communication terminal devices 1 having the second attribute without having to perform any operations at all. As an example, where the communication terminal device 1 having the first attribute is disposed at, for example, a reception, and the communication terminal devices 1 having the second attribute are carried around by respective attendants, one of the attendants can smoothly attend to the customer without any need for a user operation.

In aspect 4 of the present invention, the communication terminal device 1 of aspect 1 or 2 thereof may be configured such that the control device performs the transmission process in response to a lack of detection of a person in a vicinity of the communication terminal device for at least a prescribed length of time. This configuration enables the user of the communication terminal device 1 having the second attribute to recognize it when the user of the communication terminal device 1 having the first attribute is away from the location of the communication terminal device 1 or when there has been no person in the vicinity of the communication terminal device 1.

The present invention, in aspect 5 thereof, is directed to a control device that controls an operation of the communication terminal device 1, the control device including: an identification unit (mode identification unit 105) configured to identify an attribute of each of other communication terminal devices 1 communicable with the communication terminal device 1; and a transmission control unit 107 configured to transmit a call request to those other communication terminal devices 1 the attribute of each of which is identified as being set to a second attribute that differs from a first attribute to which an attribute of the communication terminal device 1 is set and to transmit no call request to those other communication terminal devices 1 the attribute of each of which is identified as being set to the first attribute. This control device achieves effects similar to those achieved by aspect 1 described above.

The present invention, in aspect 6 thereof, is directed to a communication control method of controlling communications between a plurality of communication terminal devices 1 by means of either any of the plurality of communication terminal devices 1 or an information processing device communicable with the plurality of communication terminal devices 1, each of the plurality of communication terminal devices 1 having an attribute, the method including: the identification step of identifying the attribute of each of the plurality of communication terminal devices 1; and the transmission step of transmitting a call request to those of the plurality of communication terminal devices 1 the attribute of each of which is identified as being set to a second attribute that differs from a first attribute to which the attribute of one of the plurality of communication terminal devices 1 that is a sender of the call request is set, wherein in the transmission step, no call request is transmitted to those of the plurality of communication terminal devices 1 the attribute of each of which is identified as being set to the first attribute. This communication control method achieves effects similar to those achieved by aspect 1 described above.

The communication terminal device 1 and the information processing device in each aspect of the present invention may be implemented on a computer, in which case the computer is controlled so as to serve as various units and devices (software elements) in the communication terminal device 1 and the information processing device. The present invention hence encompasses a control program causing the computer to implement the communication terminal device 1 or the information processing device and also encompasses a computer-readable storage medium containing the control program.

The present invention is not limited to the description of the embodiments above and may be altered within the scope of the claims. Embodiments based on a proper combination of technical means disclosed in different embodiments are encompassed in the technical scope of the present invention. Furthermore, new technological features can be created by combining different technical means disclosed in the embodiments.

While there have been described what are at present considered to be certain embodiments of the invention, it will be understood that various modifications may be made thereto, and it is intended that the appended claim cover all such modifications as fall within the true spirit and scope of the invention.

What is claimed is:

1. A communication terminal device comprising:
at least one control device; and
at least one communication device,
the control device performing:
an identification process of identifying an attribute of each of other communication terminal devices communicable with the communication terminal device, the attribute including a first attribute and a second attribute; and
a transmission process of transmitting a call request via the communication device to those other communication terminal devices the attribute of each of which is identified as being set to the second attribute that differs from the first attribute to which an attribute of the communication terminal device is set, wherein no call request is transmitted to those other communication terminal devices the attribute of each of which is identified as being set to the first attribute.

2. The communication terminal device according to claim 1, wherein upon receiving the call request from one of the other communication terminal devices the attribute of which is identified as being set to the second attribute, the control device performs a call reception process of starting a call with that one of the other communication terminal devices irrespective of whether a user operates or does not operate the communication terminal device.

3. The communication terminal device according to claim 1, wherein the control device performs the transmission process in response to a detection of a person in a vicinity of the communication terminal device.

4. The communication terminal device according to claim 1, wherein the control device performs the transmission process in response to a lack of detection of a person in a vicinity of the communication terminal device for at least a prescribed length of time.

5. A control device that controls an operation of a communication terminal device, the control device comprising:
an identification unit configured to identify an attribute of each of other communication terminal devices communicable with the communication terminal device, the attribute including a first attribute and a second attribute; and
a transmission control unit configured to transmit a call request to those other communication terminal devices the attribute of each of which is identified as being set to the second attribute that differs from the first attribute to which an attribute of the communication terminal device is set and to transmit no call request to those other communication terminal devices the attribute of each of which is identified as being set to the first attribute.

6. A communication control method of controlling communications between a plurality of communication terminal devices by means of either any of the plurality of communication terminal devices or an information processing device communicable with the plurality of communication terminal devices, each of the plurality of communication terminal devices having an attribute including a first attribute and a second attribute, the method comprising:
the identification step of identifying the attribute of each of the plurality of communication terminal devices; and
the transmission step of transmitting a call request to those of the plurality of communication terminal devices the attribute of each of which is identified as being set to the second attribute that differs from the first attribute to which the attribute of one of the plurality of communication terminal devices that is a sender of the call request is set, wherein in the transmission step, no call request is transmitted to those of the plurality of communication terminal devices the attribute of each of which is identified as being set to the first attribute.

7. A non-transitory, computer-readable medium containing a control program causing a computer to function as the control device according to claim 5, the control program causing the computer to function as the identification unit and the transmission control unit.
